(19) United States
(12) Patent Application Publication
(10) Pub. No.: US 2026/0045973 A1
(43) Pub. Date: Feb. 12, 2026

(54) MIMO RECEIVER USING TIME-FREQUENCY CHANNEL ESTIMATES FOR NEXT GENERATION WIRELESS COMMUNICATION SYSTEMS

(71) Applicant: Indian Institute of Technology Kharagpur, Kharagpur (IN)

(72) Inventors: B.V. Sudhakar REDDY, Kharagpur (IN); Chaithanya VELAMPALLI, Kharagpur (IN); Suvra Sekhar DAS, Kharagpur (IN)

(21) Appl. No.: 18/974,848

(22) Filed: Dec. 10, 2024

(30) Foreign Application Priority Data
Aug. 7, 2024 (IN) 202431059715

(51) Int. Cl. H04B 7/0413; H04L 1/00; H04L 5/00; H04L 25/02

(52) U.S. Cl. CPC H04B 7/0413; H04L 1/0045; H04L 5/0014; H04L 25/0202

(57) ABSTRACT

Provided is a receiver for a wireless communication system, where the transmitter transmits multiple data streams in parallel, and the receiver is equipped with multiple antennas. The receiver operates in the time-frequency domain, which is used for OFDM waveforms in 5G WLAN. The receiver requires time-frequency channel estimates for processing the received signal, which can be obtained by sending time-frequency domain pilots during transmission. The receiver performs channel equalization for the symbols received from multiple antennas. Using forward error correction (FEC) decoding, it reproduces the transmitted data symbols. The reproduced symbols are used to adjust the input to the channel equalization. The channel equalization output is then normalized with a factor and added to the reproduced waveform in time frequency domain from previous iteration. Demodulation and decoding are applied again. This iterative process continues until the transmitted data bits are correctly decoded or the maximum number of iterations is reached.

### TECHNICAL FIELD

The present disclosure relates to the field of wireless communication system. Particularly, but not exclusively, the present disclosure is directed towards the development of a receiver designed for wireless communication with multiple transmit and receive antennas, commonly known as Multiple-Input Multiple-Output (MIMO), uses time-frequency channel estimates and operates iteratively.

### BACKGROUND

In Orthogonal Frequency Division Multiplexing (OFDM) transmissions, in each OFDM symbol, some subcarriers transmit data symbols, while others send pilots for tasks like channel estimation and synchronization. Each data subcarrier is regarded as one resource element, and a frame of N_{sym} consecutive OFDM symbols will contain several REs, with their number denoted as K. In OFDM, these resource elements are loaded with data quadrature amplitude modulation (QAM) or phase shift keying (PSK) symbols. In OTFS, the inverse symplectic fast Fourier transform (ISFFT) is performed on the data symbols before loading onto the resource elements.

In a MIMO system, which includes multi-antenna transmission and reception, P data symbols are transmitted over each resource element. Here, P represents the number of layers or parallel data streams. MIMO precoding is used to match the P layers to T antenna streams. In closed-loop systems, codebooks are utilized for MIMO precoding, ensuring that P≤T The selection of the appropriate codebook is dependent on the channel state information (CSI) feedback from the receiver. In high mobility scenarios, where the CSI feedback from the receiver becomes obsolete at the time of actual transmission, open-loop MIMO is preferred.

In a non-patent literature, [R. Bomfin, M Chafii, A. Nimr and G. Fettweis, “A Robust Baseband Transceiver Design for Doubly-Dispersive Channels,” in IEEE Transactions on Wireless Communications, vol. 20, no. 8, pp. 4781-4796, August 2021.], three different concepts for robust link-level performance under doubly-dispersive wireless channels are investigated, namely, i) channel estimation, ii) cyclic prefix (CP)-free transmission, and iii) waveform design. A unique word-based channel estimation is employed, where the channel related errors are decoupled into channel estimation error (CEE) and Doppler error (DE). Then, a trade-off between CEE and DE emerges in the frame design is shown, where the system can be optimized to achieve the minimum composite channel error. Another strategy to improve the link-level performance is to suppress the CP of the sub-blocks. This allows for better channel estimation due to the reduced transmission time, with the penalty of requiring the CP-restoration processing at the receiver. Furthermore, the waveform design is proposed based on the equal-reliability criterion (ERC), leading to the block multiplexing-orthogonal chirp division multiplexing (BM-OCDM). This waveform is advantageous in the CP-free transmission mode, where the data symbols have equally distributed interference from adjacent sub-blocks. The framework is a generalization of the recently proposed orthogonal time frequency space (OTFS), which fails to achieve the ERC. The link-level simulations show that at high modulation and coding scheme, the proposed BM-OCDM provides superior link-level performance than OTFS. Therefore, a new receiver is introduced for OTFS. However, the receiver is not compatible for spatial multiplexing MIMO configuration.

In another non-patent literature, [M. Matth'e, D. Zhang and G. Fettweis, “Low-Complexity Iterative MAMSE-PIC Detection for MIMO-GFDM,” in IEEE Transactions on Communications, vol. 66, no. 4, pp. 1467-1480, April 2018.], a low-complexity formulation is proposed for iterative minimum mean squared error with parallel interference cancellation (MMSE-PIC) detection for non-orthogonal waveforms with localized inter-carrier interference, where it is focused on the application to MIMO-GFDM. The proposal achieves complexity similar to CP-OFDM and its performance is evaluated under realistic channel conditions with imperfect channel state information, where up to 2-dB gain of GFDM is obtained compared with OFDM. Such findings are confirmed by analyzing the measured extrinsic information transfer charts and it is showed that the proposal achieves the performance of optimal maximum likelihood detection. The results point out the MMSE-PIC algorithm as a viable technique for iterative MIMO receiver implementations for non-orthogonal waveforms. Therefore, A MIMO receiver is given for OFDM as the underlying waveform. However, the receiver is not compatible for OTFS waveform.

In another non-patent literature, [T. Thaj and E. Viterbo, “Low-Complexity Linear Diversity-Combining Detector for MIMO-OTFS,” in IEEE Wireless Communications Letters, vol. 11, no. 2, pp. 288-292, February 2022.], a low complexity detector is proposed for multiple-input multiple-output (MIMO) systems based on the recently proposed orthogonal time frequency space (OTFS) modulation. In the proposed detector, the copies of the transmitted symbol-vectors received through the different diversity branches (propagation paths and receive antennas) are linearly combined using the maximum ratio combining (MRC) technique to iteratively improve the signal to interference plus noise ratio (SINR) at the output of the combiner. To alleviate the performance degradation due to spatial correlation at the receiver antennas, a sample-based method is presented to estimate such correlation and find the optimized combining weights for MRC from the estimated correlation matrix. The detector performance and complexity improve over the linear minimum mean square error (LMMSE) and message passing (MP) detectors proposed in the literature for MIMO-OTFS. A MIMO-OTFS receiver is given. It requires time domain or delay-Doppler domain channel estimates for receive signal processing.

In another non-patent literature, [H Qu, G. Liu, M. A. Imran, S. Wen and L. Zhang, “Efficient Channel Equalization and Symbol Detection for MIMO OTFS Systems,” in IEEE Transactions on Wireless Communications, vol. 21, no. 8, pp. 6672-6686, August 2022.], a time-space domain channel equalizer is proposed, relying on the mathematical least squares minimum residual algorithm, to remove the channel distortion on data symbols. The proposed channel equalizer adopts a recursion method to achieve symbol estimates, which can realize fast convergence by leveraging the sparsity of MIMO-OTFS channel matrix. Instead of directly remapping the equalized OTFS symbols into data bits, an enhanced data detection (EDD) scheme is developed to iteratively demodulate the superposed multi-antenna signal. The EDD can not only realize the linear-complexity interference cancellation, but also efficiently reap the spatial and multi-path diversities of MIMO-OTFS channel. The simulations show the proposed channel equalization and EDD algorithms enable the MIMO-OTFS receiver to robustly demodulate multi-stream 256-ary quadrature amplitude modulation symbols, under a maximum velocity of 550 km/h at 5.9 GHz carrier frequency. A MIMO-OTFS receiver is presented. This receiver also requires time domain channel estimates for signal processing.

In another patent literature, U.S. Pat. No. 10,693,692B2 titled “Receiver-side processing of orthogonal time frequency space modulated signals” discloses wireless communication techniques for transmitting and receiving reference signals is described. The reference signals may include pilot signals that are transmitted using transmission resources that are separate from data transmission resources. Pilot signals are continuously transmitted from a base station to user equipment being served. Pilot signals are generated from delay-Doppler domain signals that are processed to obtain time-frequency signals that occupy a two-dimensional lattice in the time frequency domain that is non-overlapping with a lattice corresponding to data signal transmissions. Therefore, hard decisions are used in decision feedback loop and hence errors propagate from iteration to iteration and cause a loss in performance.

There is a clear need for innovation in wireless communication systems so as to yield a better performance with open loop or closed loop MIMO and support high mobility scenarios.

### SUMMARY

One or more shortcomings of the prior art are overcome, and additional advantages are provided through the present disclosure. Additional features and advantages are realized through the techniques of the present disclosure. Other embodiments and aspects of the disclosure are described in detail herein and are considered a part of the claimed disclosure.

The present disclosure related to a method of receiving data symbols using time-frequency channel estimation in a receiver having one or more input and multiple output (MIMO) and adapted to any precoding based OFDM transmissions. The method comprises receiving at a base station or access point, or any hand held device, one or more parallel data streams including a plurality of data symbols from one or more resource elements (RE). The received data symbols are pre-coded and the pre-coded output samples are transmitted by respective data subcarrier via orthogonal frequency division multiplexing (OFDM) transmission and each resource element is capable of carrying the plurality of data symbols/pre-coded samples on one data subcarrier. The method includes processing the received samples by converting from Radio Frequency (RF) to baseband and synchronizing in time and frequency, performing OFDM demodulation, for frame of OFDM symbols received from each antenna by removing Cyclic Prefix (CP) and performing fast Fourier transform (FFT) for each OFDM symbol. The method further comprises forming an effective channel matrix using time-frequency channel estimates between a plurality of links for transmitted plurality of data streams and plurality of receive antennas corresponding to each resource element. The method also includes performing channel equalization for the received samples of plurality of receive antennas in order to generate a set of channel equalized samples for each stream of transmission, normalizing the set of channel equalized samples with respective normalization co-efficient computed for each data stream, and regenerating transmitted pre-coded samples based on respective precoding for each data stream.

The present disclosure relates to a receiver having one or more input and multiple output and adapted to any precoding based OFDM transmissions. The receiver comprises a plurality of antennas configured for receiving analog wireless signal from one or more transmitters corresponding to one or more users; a plurality of analog-to-digital converter (ADC) devices for converting analog wireless signals to corresponding digital signals; at least one processor communicatively coupled with the one or more antennas and the plurality of ADC devices. In one embodiment, the at least one processor is configured to receive at a base station or access point, or any hand held device, one or more parallel data streams including a plurality of data symbols from one or more resource elements (RE). The received data symbols are pre-coded and the pre-coded output samples transmitted by respective data subcarrier via orthogonal frequency division multiplexing (OFDM) transmission and each resource element is capable of carrying the plurality of data symbols/pre-coded samples on one data subcarrier. The processor is further configured to process the received samples by converting from Radio Frequency (RF) to baseband and synchronizing in time and frequency, perform OFDM demodulation, for frame of OFDM symbols received from each antenna by removing Cyclic Prefix (CP) and performing fast Fourier transform (FFT) for each OFDM symbol. The processor forms an effective channel matrix using time-frequency channel estimates between a plurality of links for transmitted plurality of data streams and plurality of receive antennas corresponding to each resource element, and performs channel equalization for the received samples of plurality of receive antennas in order to generate a set of channel equalized samples for each stream of transmission. The processor is also configured to normalize the set of channel equalized samples with respective normalization co-efficient computed for each data stream, and regenerate transmitted pre-coded samples based on respective pre-coding for each data stream.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristics of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates a system model for MIMO-OTFS;

FIG. 2 illustrates a MIMO-OTFS receiver as proposed, in accordance with an embodiment of the present disclosure;

FIG. 3 illustrates a flow chart of a method (300) of MIMO-OTFS receiver, in accordance with an embodiment of the present disclosure;

FIG. 4 illustrates a detailed flow chart of method step 314 for regenerating transmitted pre-coded samples, in accordance with an embodiment of the present disclosure;

FIG. 5 illustrates a detailed flow chart of method step 314 for regenerating transmitted pre-coded samples in each of subsequent iterations, in accordance with an embodiment of the present disclosure; and

FIG. 6 illustrates coded BLER performance of the invented MIMO-OTFS receiver for different configurations T×R, in accordance with an embodiment of the present disclosure.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the forms disclosed, but on the contrary, the disclosure is to cover all modifications, equivalents, and alternatives falling within the spirit and the scope of the disclosure.

The terms “comprises”, “comprising”, or any other variations thereof, are intended to cover a non-exclusive inclusion, such that a setup, device, or process that comprises a list of components or steps does not include only those components or steps but may include other components or steps not expressly listed or inherent to such setup or device or process. In other words, one or more elements in a system or apparatus proceeded by “comprises . . . a” does not, without more constraints, preclude the existence of other elements or additional elements in the system or apparatus.

The present disclosure related to a receiver for a wireless communication system, where the transmitter transmits multiple data streams in parallel, and the receiver is equipped with multiple antennas. The receiver operates in the time-frequency domain, which is used for OFDM waveforms in 5G, WLAN systems etc. It supports new waveforms that can be processed as a preprocessing step to OFDM. The receiver requires time-frequency channel estimates for processing the received signal, which can be obtained by sending time-frequency domain pilots during transmission. Using these channel estimates, the receiver performs channel equalization for the symbols received from multiple antennas. It then demodulates and decodes each transmitted data stream. Using forward error correction (FEC) decoding, it reproduces the transmitted data symbols. The reproduced symbols are used to adjust the input to the channel equalization. The channel equalization output is then normalized with a factor and added to the reproduced waveform in time frequency domain from previous iteration. Demodulation and decoding are applied again. This iterative process continues until the transmitted data bits are correctly decoded or the maximum number of iterations is reached.

In the following detailed description of the embodiments of the disclosure, reference is made to the accompanying drawings that form a part hereof, and which are shown by way of illustration-specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The orthogonal frequency division multiplexing (OFDM) waveform, used in recent communication technologies, often suffers from inter-carrier interference (ICI) in high mobility scenarios. A more robust waveform, known as orthogonal time frequency space (OTFS), has been proposed for these scenarios. For compatibility with OFDM based systems, it's preferred to implement OTFS as a preprocessing stage to OFDM modulation. However, receivers for this OTFS and OFDM combination haven't been developed for multiple input multiple output (MIMO) systems, which can transmit multiple parallel data streams for higher data rates.

This proposed invention introduces a receiver design for the OTFS waveform, or any other waveform created with precoding or preprocessing before the OFDM modulation, in MIMO systems.

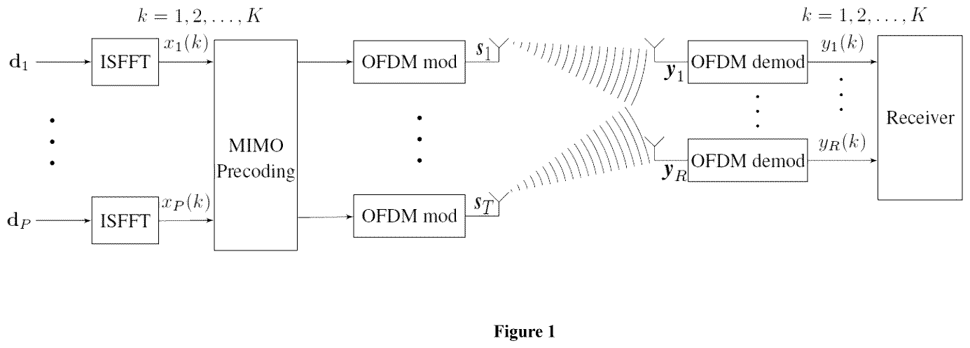

FIG. 1 shows the system model for MIMO-OTFS. The same system model can be extended to other waveforms based on orthogonal precoding, by replacing the ISFFT block with other transforms. In each frame, the data bits input for each p^{th} transmission layer, where p=1, 2, . . . , P, are forward error correction (FEC) encoded and bit interleaved. These bits are then mapped to quadrature amplitude modulation (QAM) or phase shift keying (PSK) symbols of constellation with size [symbol] 3. These symbols are included in a vector dₚ with a length of K and applied to inverse symplectic fast Fourier transform (ISFFT) for OTFS modulation as:

$${x}_{p} = ( {F}_{N}^{H} ⊗ {F}_{M} ) {d}_{p} , \qquad ( 1 )$$

where

$${F}_{N}^{H}$$

is an inverse discrete Fourier transform (IDFT) matrix of order N and F_{M} is a DFT matrix of order M. The parameters M and N are grid parameters and their product M N=K. For each k^{th} resource element, the input to the MIMO precoding block is expressed in terms of the OTFS samples xₚ=[xₚ(1), xₚ(2), . . . , xₚ(k), . . . xₚ(K)]^{T}, as:

$$x ( k ) = {[ \begin{matrix}{x}_{1} ( k ) \\ {x}_{2} ( k ) \\ ⋮ \\ {x}_{p} ( k ) \\ ⋮ \\ {x}_{P} ( k )\end{matrix} ]}_{P \times 1} \qquad ( 2 )$$

The MIMO precoding block maps the P input samples to T antennas. These samples are then placed onto the data subcarriers of N_{sym} OFDM symbols at each antenna. Pilot symbols also undergo MIMO precoding separately and are mapped to antennas, where they are placed onto the pilot subcarriers. The inverse fast Fourier transform (IFFT) operation is used to generate each time domain OFDM symbol. A cyclic prefix (CP) is then added and the N_{sym} OFDM symbols are passed to the digital to analog(A/D) converter and Radio Frequency (RF) chain for transmission at each antenna. T antennas transmit T time domain signals, S₁, S₂, . . . , S_{T}, as shown in FIG. 1. For brevity, the A/D converter and RF chain are not shown.

At the receiver, with R receive antennas, the received signals y₁, y₂, . . . , yᵣ, . . . , y_{R} undergo conversion from Radio Frequency (RF) to baseband, and are synchronized in time and frequency. For each r^{th} receive antenna, after RF to baseband conversion and synchronization, OFDM demodulation is performed on the frame of N_{sym} OFDM symbols. This process includes removal of the Cyclic Prefix (CP) and the fast Fourier transform (FFT) for each OFDM symbol. The RF to baseband conversion and time and frequency synchronization circuitry are omitted in FIG. 1 for the sake of brevity. After OFDM demodulation, for a specific k^{th} resource element, the output from R receive antennas is represented in vector form as:

$$y ( k ) = {[ \begin{matrix}{y}_{1} ( k ) \\ {y}_{2} ( k ) \\ ⋮ \\ {y}_{r} ( k ) \\ ⋮ \\ {y}_{R} ( k )\end{matrix} ]}_{R \times 1} , \qquad ( 3 )$$

where yᵣ(k) is the output for k^{th} resource element from r^{th} receive antenna.

Using pilot subcarriers, channel estimation, which includes the effect of MIMO precoding, is performed for all resource elements between transmission layers and receive antennas. The estimated channel in matrix form for each k^{th} resource element is represented as:

$$H ( k ) = {[ \begin{matrix}{h}_{11} ( k ) & {h}_{12} ( k ) & … & {h}_{1 P} ( k ) \\ {h}_{21} ( k ) & {h}_{22} ( k ) & … & {h}_{2 P} ( k ) \\ ⋮ & ⋮ & ⋱ & ⋮ \\ {h}_{R 1} ( k ) & {h}_{R 2} ( k ) & … & {h}_{RP} ( k )\end{matrix} ]}_{R \times P} \qquad ( 4 )$$

For ideal channel estimation and ignoring the time varying effects of the channel, y(k) can be expressed in terms of H(k) and x(k) as:

$$y ( k ) = H ( k ) x ( k ) + w ( k ) , \qquad ( 5 )$$

where w(k) is the additive white Gaussian noise with variance

$${σ}_{w}^{2} .$$

$$w ( k ) = {[ \begin{matrix}{w}_{1} ( k ) \\ {w}_{2} ( k ) \\ ⋮ \\ {w}_{R} ( k )\end{matrix} ]}_{R \times 1}$$

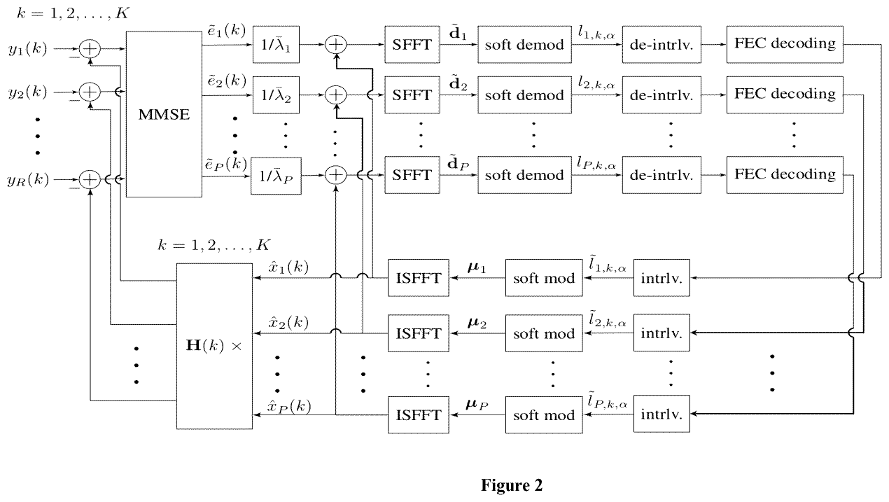

The proposed iterative receiver's block diagram is provided in FIG. 2. The operation of each constituent block is explained below.

### Minimum Mean-Square Estimation (MMSE) Equalization:

A resource element-wise MMSE equalization is performed on the error term y(k)−H(k)\hat{x}(k), where \hat{x}(k) represents the regenerated OTFS samples using the FEC decoder output from the previous iteration. In the first iteration \hat{x}(k) is set to a zero vector as:

$$\hat{x} ( k ) = {[ \begin{matrix}{\hat{x}}_{1} ( k ) \\ {\hat{x}}_{2} ( k ) \\ ⋮ \\ {\hat{x}}_{p} ( k )\end{matrix} ]}_{P \times 1} = {0}_{P} , \qquad ( 6 )$$

For k=1, 2, . . . , K, the MMSE output is expressed as:

$$\overline{e} ( k ) = {[ \begin{matrix}\text{?} ( k ) \\ \text{?} ( k ) \\ ⋮ \\ \text{?} ( k )\end{matrix} ]}_{P \times 1} = {H ( k )}^{H} {( H ( k ) {\sum }_{s} {H ( k )}^{H} + σ \text{?} {I}_{R} )}^{- 1} ( y ( k ) - H ( k ) x ( k ) ) . \qquad ( 7 )$$

$$where ,$$

$${\sum }_{s} = diag ( {[ {σ}_{1}^{2} , {σ}_{2}^{2} , … , {σ}_{p}^{2} , … , {σ}_{P}^{2} ]}^{T} ) , \qquad ( 8 )$$

$$\text{?} \text{indicates text missing or illegible when filed}$$

with

$${σ}_{p}^{2}$$

as symbol variance of the p^{th} layer. In the first iteration,

$${σ}_{p}^{2}$$

is set to unity, for p=1, 2, . . . , P.

For an unbiased MMSE, finding the normalization coefficients to divide the MMSE output as:

$$A ( k ) = {[ \begin{matrix}{λ}_{1} ( k ) \\ {λ}_{2} ( k ) \\ ⋮ \\ {λ}_{p} ( k )\end{matrix} ]}_{P \times 1} = diag ( {H ( k )}^{H} {( H ( k ) {\sum }_{s} {H ( k )}^{H} + {σ}_{w}^{2} {I}_{R} )}^{- 1} H ( k ) ) \qquad ( 9 )$$

To reduce the complexity, forming a single normalization coefficient for all the samples in each p^{th} layer as:

$${\overline{λ}}_{p} = \frac{1}{K} {{\sum }_{k = 1}}^{K} {λ}_{p} ( k ) . \qquad ( 10 )$$

Estimates for OTFS samples in (2) are obtained by adding the regenerated OTFS samples from the previous iteration to the normalized MMSE output as:

$${\tilde{x}}_{p} ( k ) = {\hat{x}}_{p} ( k ) + \frac{\text{?} ( k )}{{\overline{λ}}_{p}} \qquad ( 11 )$$

$$\text{?} \text{indicates text missing or illegible when filed}$$

### SFFT:

Performing SFFT on all the K samples \tilde{x}ₚ=[\tilde{x}ₚ(1), \tilde{x}ₚ(2), . . . , \tilde{x}ₚ(K)] for OTFS demodulation as:

$${\tilde{d}}_{p} = ( {F}_{N} ⊗ {F}_{M}^{H} ) {\tilde{x}}_{p} \qquad ( 12 )$$

The noise variance for the data symbol estimates \tilde{d}ₚ is given as:

$${σ}_{e , p}^{2} = \frac{1}{{\overline{λ}}_{p}} - {σ}_{p}^{2} . \qquad ( 13 )$$

### Soft Demodulation:

For each element in the input to soft demodulation, \tilde{d}ₚ=[\tilde{d}ₚ(1), \tilde{d}ₚ(2), . . . , \tilde{d}ₚ(K)]^{T}, n log-likelihood ratio (LLR) values are calculated, where n=log₂( [symbol] ), as below:

$${l}_{p , k , α} \approx \frac{1}{{σ}_{e , p}^{2}} ( {min}_{s ∈ {S}_{α}^{0}} {‖ {\tilde{d}}_{p} ( k ) - s ‖}^{2} - {min}_{s ∈ {S}_{α}^{1}} {‖ {\tilde{d}}_{p} ( k ) - s ‖}^{2} ) , \qquad ( 14 )$$

where l_{p,k,α} is the LLR value for the α^{th} bit out of n bits for \tilde{d}ₚ(k). The sets

$${S}_{α}^{1} and {S}_{α}^{0}$$

represent all constellation points where the α^{th} bit is 1 and 0, respectively.

### De-Interleaving:

As the coded bits of each layer are interleaved in the transmission side, the output LLR values of soft demodulation in the receiver are fed to a de-interleaver.

### FEC Decoding:

The de-interleaved LLR values of each layer are input into the soft-input soft-output (SISO) FEC decoder. This block retrieves the transmitted data bits. A decision is then made to stop the iterations if all FEC-encoded code blocks (CBs) orbits are decoded correctly.

### Interleaver:

For each p^{th} layer, the output soft values from FEC decoder are interleaved as is done in the transmission side for the coded bits.

### Soft Modulation:

After the interleaver, the soft values \tilde{l}_{p,k,α} are used to regenerate the transmitted data symbols dₚ using soft modulation. To do this, the probabilities that the soft value represents bit 1 and bit 0 are first obtained using

$$Pr ( {\tilde{l}}_{p , k , α} \to 1 ) = \frac{1}{1 + \text{?}} , and \qquad ( 15 )$$

$$Pr ( {\tilde{l}}_{p , k , α} \to 0 ) = \frac{1}{1 + \text{?}} , \qquad ( 16 )$$

$$\text{?} \text{indicates text missing or illegible when filed}$$

respectively. The probability that each group of n soft values represents the m^{th} point Sₘ of the constellation S, which has the bit sequence b_{m,n}b_{m,n-1} . . . b_{m,1}, is computed for m=1, 2, . . . [symbol] as:

$$Pr ( {\tilde{l}}_{p , k , n} {\tilde{l}}_{p , k , n - 1} … {\tilde{l}}_{p , k , 1} \to {s}_{m} ) = {\prod }_{α = 1}^{π} Pr ( {\tilde{l}}_{p , k , α} \to {b}_{m , α} ) . \qquad ( 17 )$$

Using (17), each k^{th} soft modulation symbol of each p^{th} layer, for k=1, 2, . . . , K and p=1, 2, . . . , P, is expressed as:

$${μ}_{p} ( k ) = {\sum }_{m = 1}^{ℳ} Pr ( {\tilde{l}}_{p , k , n} {\tilde{l}}_{p , k , n - 1} … {\tilde{l}}_{p , k , 1} \to {s}_{m} ) {s}_{m} , \qquad ( 18 )$$

The variance associated with each soft modulation symbol is expressed as:

$${σ}_{p , k}^{2} = {\sum }_{m = 1}^{ℳ} Pr ( {\tilde{l}}_{p , k , n} {\tilde{l}}_{p , k , n - 1} … {\tilde{l}}_{p , k , 1} \to {s}_{m} ) {( {s}_{m} - {μ}_{p} ( k ) )}^{2} \qquad ( 19 )$$

The average symbol variance for each p^{th} layer can be calculated as:

$${σ}_{p}^{2} = \frac{1}{K} {\sum }_{k = 1}^{K} {σ}_{p , k}^{2} \qquad ( 20 )$$

The values for

$${σ}_{p}^{2} ,$$

where p=1, 2, . . . , P are used in (8) and (13) for next iteration.

### ISFFT:

Performing ISFFT operation on each p^{th} layer regenerated soft modulation symbols μₚ=[μₚ(1), μₚ(2), . . . , μₚ(K)] to regenerate OTFS samples of (2) as:

$${\hat{x}}_{p} = ( {F}_{N}^{H} ⊗ {F}_{M} ) {μ}_{p} . \qquad ( 21 )$$

For a given k, the regenerated OTFS samples of all layers \hat{x}ₚ=[\hat{x}ₚ(1), \hat{x}ₚ(2), . . . , \hat{x}ₚ(K)], for p=1, 2, . . . , P, can be represented in vector form as:

$$\hat{x} ( k ) = {[ \begin{matrix}{\hat{x}}_{1} ( k ) \\ {\hat{x}}_{2} ( k ) \\ ⋮ \\ {\hat{x}}_{P} ( k )\end{matrix} ]}_{P \times 1} . \qquad ( 22 )$$

The \hat{x}(k) multiplies with the estimated channel matrix in (4) and is subtracted resource element-wise from the OFDM demodulation output in (3) before the MMSE equalization in the subsequent iteration. The \hat{x}(k) is then added to the normalized MMSE output, as stated in (11), in the next iteration.

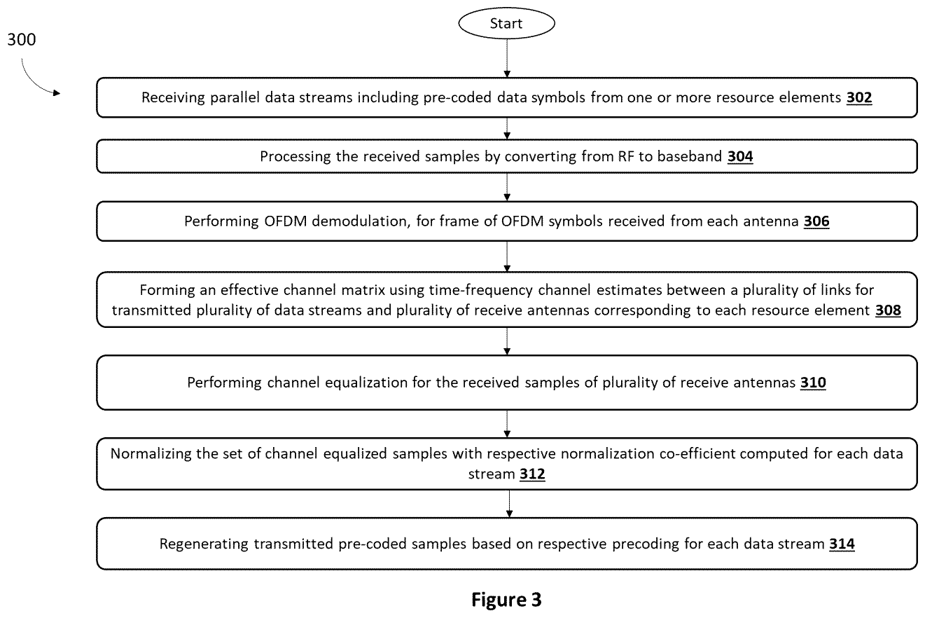

FIG. 3 illustrates a flow chart of a method (300) of MIMO-OTFS receiver, in accordance with an embodiment of the present disclosure. The method (300) comprises time-frequency channel estimation in the received signal by the MIMO-OTFS receiver. As depicted in FIG. 3, the method (300) includes a series of steps 302 through 314 for time-frequency channel estimation. The details of the method (300) have been explained below in forthcoming paragraphs. The order in which the method steps are described below is not intended to be construed as a limitation, and any number of the described method steps can be combined in any appropriate order to execute the method or an alternative method. The method (300) begins from a start block and starts execution of operations at step (302), as shown in FIG. 3.

At step (302), in a first iteration, the method (300) comprises receiving, by a plurality of antennas of the MIMO receiver at a base station or access point, or any hand held device, one or more parallel data streams including a plurality of data symbols from one or more resource elements (RE), wherein the received data symbols are pre-coded and the pre-coded output samples are transmitted by respective data subcarrier via orthogonal frequency division multiplexing (OFDM) transmission and each resource element is capable of carrying the plurality of data symbols/pre-coded samples on one data subcarrier. The flow of the method (300) now proceeds to step (304).

At step (304), in the first iteration, the method (300) comprises processing the received samples by converting from Radio Frequency (RF) to baseband and synchronizing in time and frequency. The flow of the method (300) now proceeds to step (306).

At step (306), in the first iteration, the method (300) comprises performing OFDM demodulation, for frame of OFDM symbols received from each antenna by removing Cyclic Prefix (CP) and performing fast Fourier transform (FFT) for each OFDM symbol. After OFDM demodulation, for a specific k^{th} resource element, the output from R receive antennas is represented in vector as demonstrated by Equation 3. The flow of the method (300) now proceeds to step (308).

At step (308), in the first iteration, the method (300) comprises forming an effective channel matrix using time-frequency channel estimates between a plurality of links for transmitted plurality of data streams and plurality of receive antennas corresponding to each resource element. The estimated channel in matrix form for each k^{th} resource element is represented as demonstrated by Equation 4. The time frequency channel is estimated by a channel estimation block in the receiver, that estimates the time-frequency channel for MIMO by processing pilot subcarriers, wherein the pilot subcarriers are inserted between the data subcarriers of OFDM symbols in a frame as per the physical layer frame format of the OFDM transmitter. The flow of the method (300) now proceeds to step (310).

At step (310), in the first iteration, the method (300) comprises performing, by a channel equalization technique using a channel equalization matrix formed with the effective channel matrix for corresponding resource element, channel equalization for the received samples of plurality of receive antennas in order to generate a set of channel equalized samples for each stream of transmission. The flow of the method (300) now proceeds to step (312).

At step (312), in the first iteration, the method (300) comprises normalizing the set of channel equalized samples with respective normalization co-efficient computed for each data stream. In an example, estimates for OTFS samples in Equation 2 are obtained by using the normalized MMSE output as demonstrated in Equation 11. The regenerated OTFS samples using the FEC decoder in the first iteration is set to zero vector. The flow of the method (300) now proceeds to step (314).

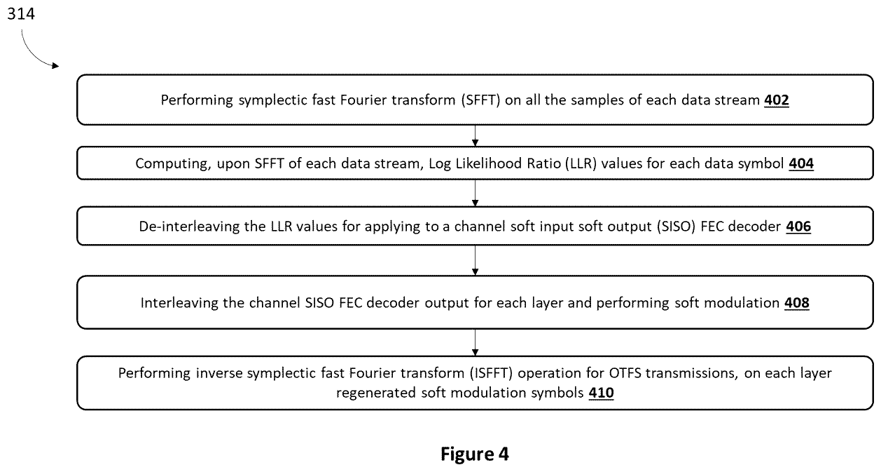

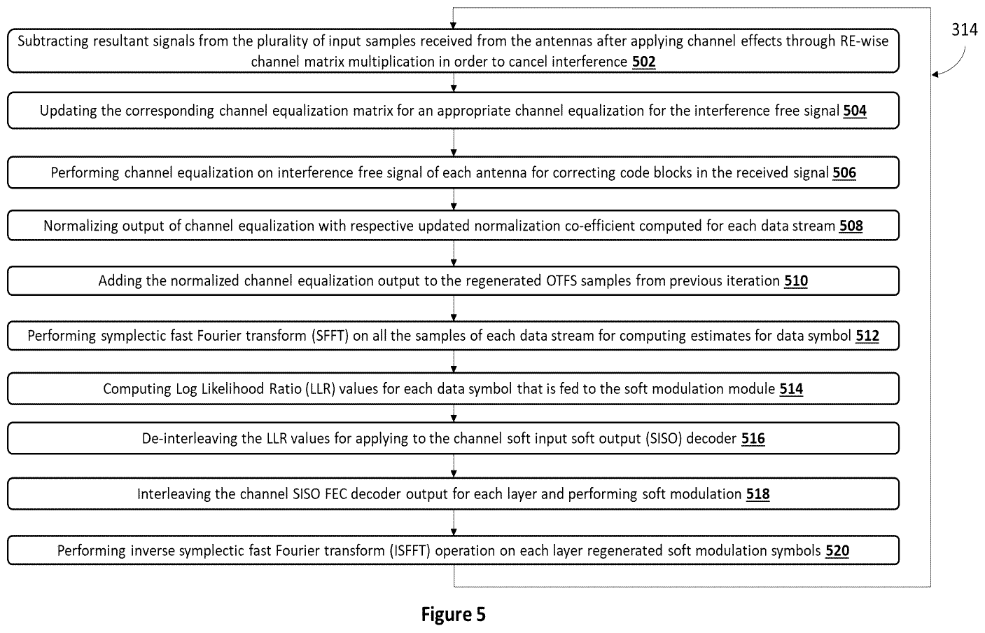

At step (314), in the first iteration, the method (300) comprises regenerating transmitted pre-coded samples based on respective precoding for each data stream. Detailed steps of regenerating transmitted pre-coded samples is disclosed in FIG. 4 of the present disclosure. Further, details of subsequent iterations are clearly disclosed in FIG. 5 of the present disclosure.

While the above-discussed steps in FIG. 3 are shown and described in a particular sequence, the steps may occur in variations to the sequence in accordance with various embodiments. Further, a detailed description related to the various steps of FIG. 3 is already covered in the description related to FIGS. 1-2 and is omitted herein for the sake of brevity.

FIG. 4 illustrates a detailed flow chart of a method step (314) for regenerating transmitted pre-coded samples, in accordance with an embodiment of the present disclosure. As depicted in FIG. 4, the method (314) includes a series of steps (402) through (410) for regenerating transmitted pre-coded samples. The method step (314) for regenerating transmitted pre-coded samples is performed for the initial iteration. The method (314) begins execution of operations at step (402), as shown in FIG. 4.

At step (402), the method (314) comprises performing symplectic fast Fourier transform (SFFT), in case of OTFS, on all the samples of each data stream for computing estimates for data symbol. Further, performing SFFT on all the K samples for OTFS demodulation as demonstrated in Equation 12. The flow of the method (314) now proceeds to step (404).

At step (404), the method (314) comprises computing, upon SFFT of each data stream, Log Likelihood Ratio (LLR) values for each data symbol that is fed to a soft modulation module. For each element in the input to soft demodulation, likelihood ratio (LLR) values are calculated as demonstrated in Equation 14. The flow of the method (314) now proceeds to step (406).

At step (406), the method (314) comprises de-interleaving the LLR values for applying to a channel soft input soft output (SISO) FEC decoder. As the coded bits of each layer are interleaved in the transmission side, the output LLR values of soft demodulation in the receiver are fed to a de-interleaver. The de-interleaved LLR values of each layer are input into the soft-input soft-output (SISO) FEC decoder. This block retrieves the transmitted data bits. A decision is then made to stop the iterations if all FEC-encoded code blocks (CBs) or bits are decoded correctly. The flow of the method (314) now proceeds to step (408).

At step (408), interleaving the channel SISO FEC decoder output for each layer and performing soft modulation. For each p^{th} layer, the output soft values from FEC decoder are interleaved as is done in the transmission side for the coded bits. The flow of the method (314) now proceeds to step (410).

At step (410), the method (314) comprises performing inverse symplectic fast Fourier transform (ISFFT) operation for OTFS transmissions, on each layer regenerated soft modulation symbols. After the interleaver, the soft values \tilde{l}_{p,k,α} are used to regenerate the transmitted data symbols dₚ using soft modulation. The regeneration of OTFS samples by ISFFT operation is demonstrated in Equation 21.

While the above-discussed steps in FIG. 4 are shown and described in a particular sequence, the steps may occur in variations to the sequence in accordance with various embodiments. Further, a detailed description related to the various steps of FIG. 4 is already covered in the description related to FIGS. 1-2 and is omitted herein for the sake of brevity.

FIG. 5 illustrates a detailed flow chart of a method step (314) for regenerating pre-coded samples for each data stream in each of subsequent iterations, in accordance with an embodiment of the present disclosure. As depicted in FIG. 5, the method (314) includes a series of steps (502) through (520) for performing the interference cancellation. The method step (314) for regenerating pre-coded samples for each data stream in second iteration and each subsequent iterations. The method (314) begins execution of operations at step (502), as shown in FIG. 5.

At step (502), in second iteration and each subsequent iterations, the method (314) comprises upon applying channel effects to the regenerated OTFS samples in each layer through resource element wise channel matrix multiplication, subtracting the resultant signals from the plurality of input samples received from the plurality of antennas in order to cancel interference. The flow of the method (314) now proceeds to step (504).

At step (504), in second iteration and each subsequent iterations, the method (314) comprises updating the corresponding channel equalization matrix for an appropriate channel equalization for the interference free signal, wherein the corresponding channel equalization matrix is updated based on the soft modulated QAM symbols which are generated from the soft values from FEC decoding from previous iteration. The flow of the method (314) now proceeds to step (506).

At step (506), in second iteration and each subsequent iterations, the method (314) comprises performing, by the channel equalization technique using the updated corresponding channel equalization matrix, channel equalization on interference free signal of each antenna for correcting code blocks in the received signal. The flow of the method (314) now proceeds to step (508).

At step (508), in second iteration and each subsequent iterations, the method (314) comprises normalizing output of channel equalization with respective updated normalization co-efficient computed for each data stream, wherein the normalization coefficient is updated based on the soft modulated QAM symbols which are generated from the soft values from FEC decoding from previous iteration. The flow of the method (314) now proceeds to step (510).

At step (510), in second iteration and each subsequent iterations, the method (314) comprises adding the normalized channel equalization output to the regenerated OTFS samples from previous iteration and the resultant is applied to the symplectic fast Fourier transform (SFFT). The flow of the method (314) now proceeds to step (512).

At step (512), in second iteration and each subsequent iterations, the method (314) comprises performing symplectic fast Fourier transform (SFFT) on all the samples of each data stream for computing estimates for data symbol. The flow of the method (314) now proceeds to step (514).

At step (514), in second iteration and each subsequent iterations, the method (314) comprises computing Log Likelihood Ratio (LLR) values for each data symbol that is fed to the soft modulation module. The flow of the method (314) now proceeds to step (516).

At step (516), in second iteration and each subsequent iterations, the method (314) comprises de-interleaving the LLR values for applying to the channel soft input soft output (SISO) decoder. The flow of the method (314) now proceeds to step (518).

At step (518), in second iteration and each subsequent iterations, the method (314) comprises interleaving the channel SISO FEC decoder output for each layer and performing soft modulation. The flow of the method (314) now proceeds to step (520).

At step (520), in second iteration and each subsequent iterations, the method (314) comprises performing inverse symplectic fast Fourier transform (ISFFT) operation on each layer regenerated soft modulation symbols.

While the above-discussed steps in FIG. 5 are shown and described in a particular sequence, the steps may occur in variations to the sequence in accordance with various embodiments. Further, a detailed description related to the various steps of FIG. 5 is already covered in the description related to FIGS. 1-2 and is omitted herein for the sake of brevity.

According to an embodiment, the method steps of FIGS. 3, 4, and 5 and other operations disclosed herein are performed by the at least one processor of the MIMO receiver.

### Performance Evaluation:

The main simulation parameters are given in Table 3 for testing the invented MIMO-OTFS receiver.

TABLE 3

| Carrier frequency | 4 | GHz |
|---|---|---|
| M × N | 64 × 64 | |
| Δf | 15 | kHz |
| Channel | EVA [6] | |
| Velocity | 500 | kmph |
| Modulation | 16 | QAM |

| | |
|---|---|
| FEC coding | LDPC |
| Codeblock length | 648 |
| Code rate | ½ |
| Max. number of receiver iterations | 10 |

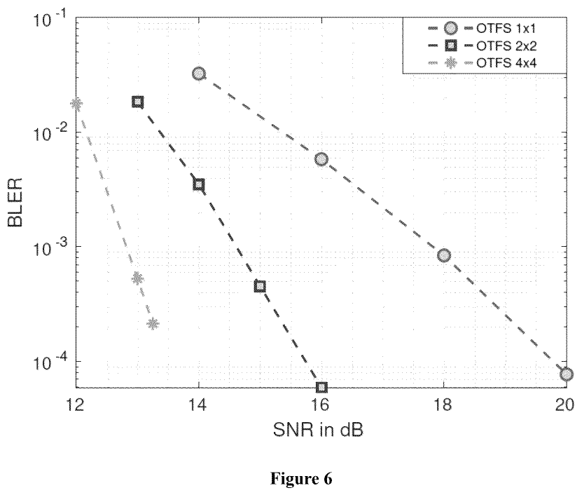

FIG. 6 shows the overall coded block error Rate (BLER) for all P transmissions, using non-codebook identity matrix-based precoding. We observe improved error performance with the increase of spatial multiplexing order. Despite the increased number of spatial streams, the receiver can utilize the receive diversity, similar to the high-complexity maximum likelihood (ML) based receiver.

This invention seamlessly incorporates OTFS into all existing OFDM-based systems, such as 5G/WLAN systems. Given that OFDM is already established for beyond 5G and 6G systems, this invention is applicable in these systems as well. As the receiver is designed to support open-loop MIMO precoding, it can be employed in high mobility scenarios such as high-speed trains (HST), non-terrestrial LEO satellite systems, and unmanned aerial vehicles (UAVs) and drones.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiment will be apparent to those skilled in the art.

In the detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The description is, therefore, not to be taken in a limiting sense.

We claim:

1. A method of detecting data symbols and corresponding data bits using time-frequency channel estimates in a receiver having one or more receiving antennas for one or more input and multiple output (MIMO) systems and adapted to any precoding based OFDM transmissions, the method comprises:
receiving, by a plurality of antennas of the MIMO receiver at a base station or access point, or any hand held device, one or more parallel data streams including a plurality of data symbols from one or more resource elements (RE), wherein the received data symbols are pre-coded and the pre-coded output samples are transmitted by respective data subcarrier via orthogonal frequency division multiplexing (OFDM) transmission and each resource element is capable of carrying the plurality of data symbols/pre-coded samples on one data subcarrier;
processing the received samples by converting from Radio Frequency (RF) to baseband and synchronizing in time and frequency;
performing OFDM demodulation, for frame of OFDM symbols received from each antenna by removing Cyclic Prefix (CP) and performing fast Fourier transform (FFT) for each OFDM symbol;
forming an effective channel matrix using time-frequency channel estimates between a plurality of links for transmitted plurality of data streams and plurality of receive antennas corresponding to each resource element;
performing, by a channel equalization technique using a channel equalization matrix formed with the effective channel matrix for corresponding resource element, channel equalization for the received samples of plurality of receive antennas in order to generate a set of channel equalized samples for each stream of transmission;
normalizing the set of channel equalized samples with respective normalization co-efficient computed for each data stream; and
regenerating transmitted pre-coded samples based on respective precoding for each data stream.

2. The method as claimed in claim 1, wherein regenerating pre-coded samples for each data stream comprises:
performing symplectic fast Fourier transform (SFFT), in case of OTFS, on all the samples of each data stream for computing estimates for data symbol;
computing, upon SFFT of each data stream, Log Likelihood Ratio (LLR) values for each data symbol that is fed to a soft modulation module;
de-interleaving the LLR values for applying to a channel soft input soft output (SISO) FEC decoder;
interleaving the channel SISO FEC decoder output for each layer and performing soft modulation; and
performing inverse symplectic fast Fourier transform (ISFFT) operation for OTFS transmissions, on each layer regenerated soft modulation symbols.

3. The method as claimed in claim 2, wherein regenerating pre-coded samples for each data stream in each of subsequent iteration comprises:
upon applying channel effects to the regenerated OTFS samples in each layer through resource element wise channel matrix multiplication, subtracting the resultant signals from the plurality of input samples s received from the plurality of antennas in order to cancel interference;
updating the corresponding channel equalization matrix for an appropriate channel equalization for the interference free signal, wherein the corresponding channel equalization matrix is updated based on the soft modulated QAM symbols which are generated from the soft values from FEC decoding from previous iteration;
performing, by the channel equalization technique using the updated corresponding channel equalization matrix, channel equalization on interference free signal of each antenna for correcting code blocks in the received signal;
normalizing output of channel equalization with respective updated normalization co-efficient computed for each data stream, wherein the normalization coefficient is updated based on the soft modulated QAM symbols which are generated from the soft values from FEC decoding from previous iteration;
adding the normalized channel equalization output to the regenerated OTFS samples from previous iteration and the resultant is applied to the symplectic fast Fourier transform (SFFT);
performing symplectic fast Fourier transform (SFFT) on all the samples of each data stream for computing estimates for data symbol;
computing Log Likelihood Ratio (LLR) values for each data symbol that is fed to the soft modulation module;
de-interleaving the LLR values for applying to the channel soft input soft output (SISO) decoder;
interleaving the channel SISO FEC decoder output for each layer and performing soft modulation; and
performing inverse symplectic fast Fourier transform (ISFFT) operation on each layer regenerated soft modulation symbols,
wherein, the subsequent iterations are executed until either all data bits are correctly received at the output of the FEC decoder, or the maximum number of iterations is reached.

4. The method as claimed in claim 3, wherein the regenerated OTFS samples using the FEC decoder in the first iteration is set to zero vector.

5. The method as claimed in claim 1, wherein the time frequency channel is estimated by a channel estimation block in the receiver, that estimates the time-frequency channel for MIMO by processing pilot subcarriers, wherein the pilot subcarriers are inserted between the data subcarriers of OFDM symbols in a frame as per the physical layer frame format of the OFDM transmitter.

6. A receiver having one or more input and multiple output and adapted to any precoding based OFDM transmissions, the receiver comprises:
a plurality of antennas configured for receiving analog wireless signal from one or more transmitters corresponding to one or more users;
a plurality of analog-to-digital converter (ADC) devices for converting analog wireless signals to corresponding digital signals;
at least one processor communicatively coupled with the one or more antennas and the plurality of ADC devices, the at least one processor is configured to:
receive, by a plurality of antennas of the receiver at a base station or access point, or any hand held device, one or more parallel data streams including a plurality of data symbols from one or more resource elements (RE), wherein the received data symbols are pre-coded and the pre-coded output samples transmitted by respective data subcarrier via orthogonal frequency division multiplexing (OFDM) transmission and each resource element is capable of carrying the plurality of data symbols/pre-coded samples on one data subcarrier;
process the received samples by converting from Radio Frequency (RF) to baseband and synchronizing in time and frequency;
perform OFDM demodulation, for frame of OFDM symbols received from each antenna by removing Cyclic Prefix (CP) and performing fast Fourier transform (FFT) for each OFDM symbol;
form an effective channel matrix using time-frequency channel estimates between a plurality of links for transmitted plurality of data streams and plurality of receive antennas corresponding to each resource element;
perform, by a channel equalization technique using the effective channel matrix formed with the effective channel matrix for corresponding resource element, channel equalization for the received samples of plurality of receive antennas in order to generate a set of channel equalized samples for each stream of transmission;
normalize the set of channel equalized samples with respective normalization co-efficient computed for each data stream; and
regenerate transmitted pre-coded samples based on respective pre-coding for each data stream.

7. The receiver as claimed in claim 6, wherein the processor is configured to regenerate pre-coded samples for each data stream by:
performing symplectic fast Fourier transform (SFFT), in case of OTFS, on all the samples of each data stream for computing estimates for data symbol;
computing, upon SFFT of each data stream, Log Likelihood Ratio (LLR) values for each data symbol that is fed to a soft modulation module;
de-interleaving the LLR values for applying to a channel soft input soft output (SISO) FEC decoder;
interleaving the channel SISO FEC decoder output for each layer and performing soft modulation; and
performing inverse symplectic fast Fourier transform (ISFFT) operation for OTFS transmissions, on each layer regenerated soft modulation symbols.

8. The receiver as claimed in claim 6, wherein the processor is configured to regenerate pre-coded samples for each data stream in each of subsequent iteration by:
upon applying channel effects to the regenerated OTFS samples in each layer through resource element wise channel matrix multiplication, subtracting the resultant signals from the plurality of input samples received from the plurality of antennas in order to cancel interference;
updating the corresponding channel equalization matrix for an appropriate channel equalization for the interference free signal, wherein the corresponding channel equalization matrix is updated based on the soft modulated QAM symbols which are generated from the soft values from FEC decoding from previous iteration;
performing, by the channel equalization technique using the updated corresponding channel equalization matrix, channel equalization on interference free signal of each antenna for correcting code blocks in the received signal;
normalizing output of channel equalization with respective updated normalization co-efficient computed for each data stream, wherein the normalization coefficient is updated based on the soft modulated QAM symbols which are generated from the soft values from FEC decoding from previous iteration;
adding the normalized channel equalization output to the regenerated OTFS samples from previous iteration and the resultant is applied to the symplectic fast Fourier transform (SFFT);
performing symplectic fast Fourier transform (SFFT) on all the samples of each data stream for computing estimates for data symbol;
computing Log Likelihood Ratio (LLR) values for each data symbol that is fed to the soft modulation module;
de-interleaving the LLR values for applying to the channel soft input soft output (SISO) decoder;
interleaving the channel SISO FEC decoder output for each layer and performing soft modulation; and
performing inverse symplectic fast Fourier transform (ISFFT) operation on each layer regenerated soft modulation symbols,
wherein, the subsequent iterations are executed until either all data bits are correctly received at the output of the FEC decoder, or the maximum number of iterations is reached.

9. The receiver as claimed in claim 6, wherein the regenerated samples using the FEC decoder in the first iteration is set to zero vector.

10. The receiver as claimed in claim 6, wherein the time frequency channel is estimated by a channel estimation block in the receiver, that estimates the time-frequency channel for MIMO by processing pilot subcarriers, wherein the pilot subcarriers are inserted between the data subcarriers of OFDM symbols in a frame as per the physical layer frame format of the OFDM transmitter.
